(19) United States
(12) Patent Application Publication
(10) Pub. No.: US 2015/0095803 A1
(43) Pub. Date: Apr. 2, 2015

(54) SOCIAL NETWORK CAPABLE OF RECOMMENDING FRIENDS AND FRIEND RECOMMENDATION METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: ZHI TAN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/098,557

(22) Filed: Dec. 6, 2013

(30) Foreign Application Priority Data
Sep. 30, 2013 (CN) 2013104574246

(51) Int. Cl. H04L 12/18; G06F 3/0481

(52) U.S. Cl. CPC H04L 12/1813; G06F 3/0481
USPC 715/753

(57) ABSTRACT

A friend recommendation method is applied for a social network. The social network stores a relationship between to-be-recommended friends and image characters of images uploaded by each to-be-recommended friend. The method includes the following steps. Obtaining all images uploaded to the social network by each user. Determining an image fingerprint of each obtained image. Determining that a combination of the image fingerprints of all the images uploaded by the user is an image character of the images uploaded by the user. Determining a similarity value between the determined image character and the stored image character of each to-be-recommended friend. Determining to recommend which of the to-be-recommended friends to one user according to the determined similarity values.

### BACKGROUND

1. Technical Field

The present disclosure relates to social networks, and particularly to a social network capable of recommending friends and a friend recommendation method adapted for the social network.

2. Description of Related Art

Online social networks, such as FACEBOOK, TWITTER, and YOUTUBE, have become extremely popular and are attracting millions of users. Such social networks, which allow different users to communicate, share information, and build virtual communities, can recommend friends to the users based on whether they have common friend. However, such friend recommendation method cannot recommend friends to the users based on the photos that the users uploaded to the social networks.

Therefore, what is needed is a means to solve the problem described above.

### BRIEF DESCRIPTION OF THE DRAWINGS

Many aspects of the present disclosure should be better understood with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of a social network capable of recommending friends, in accordance with an exemplary embodiment.

FIG. 2 is a schematic view showing an image character of images uploaded by one user.

FIG. 3 is a flowchart of a friend recommendation method, in accordance with an exemplary embodiment.

### DETAILED DESCRIPTION

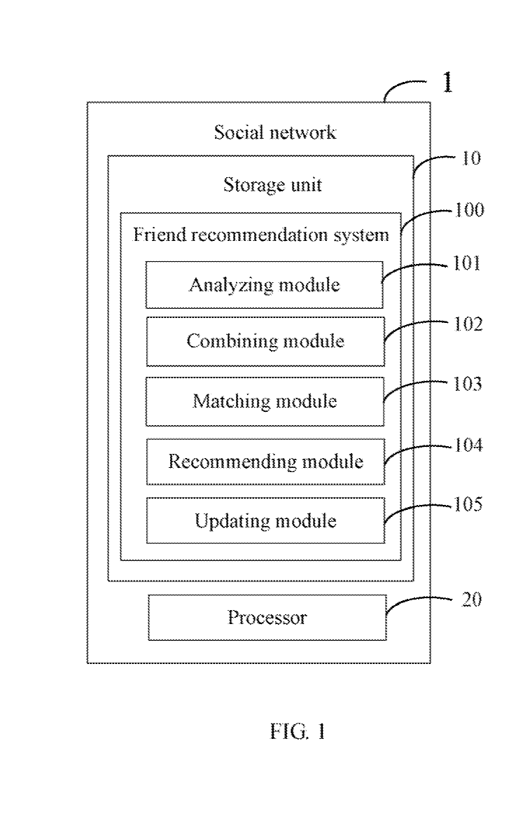

FIG. 1 is a block diagram of a social network 1 according to an exemplary embodiment. The social network 1 includes a storage unit 10 and a processor 20. The storage unit 10 includes a relationship between friends to be recommended (hereinafter, to-be-recommended friends) and image characters of images uploaded by each to-be-recommended friend. The storage unit 10 further stores a friend recommendation system 100. The system 100 includes a variety of modules executed by the processor 20 to provide the functions of the system 100. A detailed description of the variety of modules will be described as follows.

In the embodiment, the system 100 includes an analyzing module 101, a combining module 102, a matching module 103, and a recommending module 104.

The analyzing module 101 obtains all the images uploaded to the social network 1 by each user, and determines an image fingerprint of each obtained image. In the embodiment, the analyzing module 101 automatically obtains all the images uploaded to the social network 1 by one user each time the user uploads an image. In an alternative embodiment, the analyzing module 101 obtains all the images uploaded to the social network 1 by one user upon receiving a command input by the user. In detail, the analyzing module 101 determines the image fingerprint of each obtained image by a Message Digest Algorithm 5 (MD5) checksum.

In the embodiment, the analyzing module 101 identifies the human faces included in each obtained image, and determines a binary sequence corresponding to each identified human face. The binary sequence corresponding to one identified human face indicates the features of the corresponding human face. Such a binary sequence determination method is known in the art, such as the subject matter of EP Application Publication No. 0150001 A2, which is herein incorporated by reference. The analyzing module 101 further determines that a combination of the binary sequence corresponding to each identified human face in each obtained image is the image fingerprint of each obtained image.

The combining module 102 determines that a combination of the image fingerprints of all the images uploaded by each user is the image character of the images uploaded by the user.

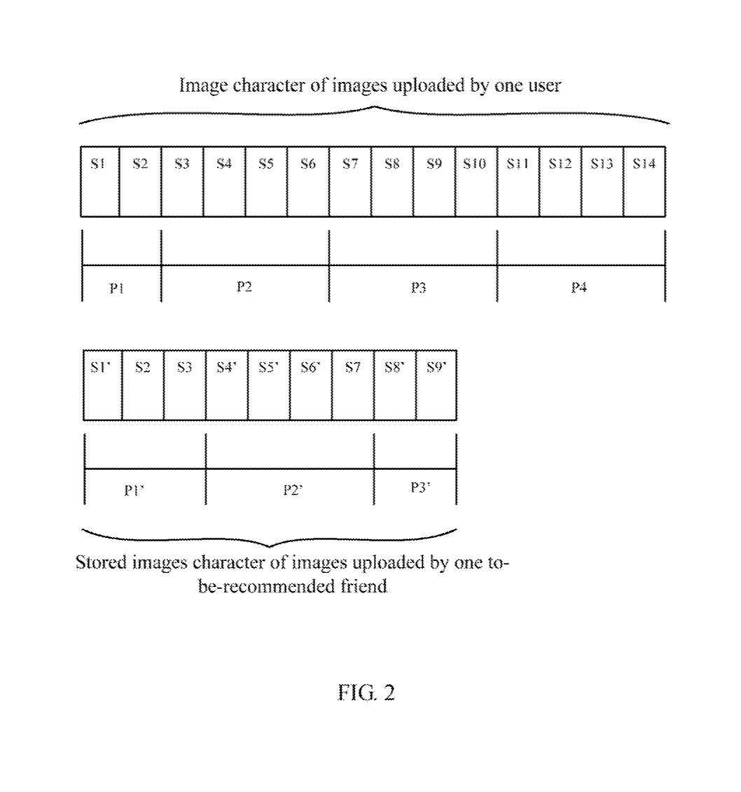

Referring to FIG. 2, a user has uploaded images P1, P2, P3 and P4 to the social network 1. The image P1 includes two human faces, and the binary sequences corresponding to the human faces are respectively binary sequences S1 and S2, so the image fingerprint of the image P1 is the combination of the binary sequences S1 and S2. The image P2 includes four human faces, and the binary sequences corresponding to the human faces are respectively binary sequences S3, S4, S5 and S6, so the image fingerprint of the image P2 is the combination of the binary sequences S3, S4, S5 and S6, and so forth. Then, the image character of the images uploaded by the user is the combination of binary sequences S1, S2, S3 . . . and S14 respectively corresponding to the human faces in the images P1, P2, P3 and P4.

The matching module 103 compares the determined image character with the stored image character of each to-be-recommended friend, and determines a similarity value between the determined image character and each stored image character according to the comparison result. In the embodiment, the matching module 103 compares the binary sequences in the determined image character with the binary sequences in each stored image character, and calculates the number of the same binary sequences between the determined image character and each stored image character. The determined number between the determined image character and the stored image character of one to-be-recommended friend indicates how many same human faces are included in the images uploaded by the user and the to-be-recommended friend. Then, the matching module 103 determines the similarity value between the determined image character and each stored image character according to the calculated number. FIG. 2 shows that if the determined image character consists of binary sequences S1, S2 . . . S14, the stored image character of one to-be-recommended friend consists of binary sequences S1′, S2 . . . S9′, thus the number of the same binary sequence (S2, S3 and S7) both in the determined image character and the stored image character is three. It is notable that the greater the determined number is, the higher the similarity value between the determined image character and the stored image character is.

The recommending module 104 determines to recommend which of the to-be-recommended friends to one user according to the determined similarity values. In the embodiment, the recommending module 104 determines at least one stored image character with a highest similarity value relative to the determined image character, and recommends the to-be-recommended friend corresponding to the determined stored image character by sending personal information of the to-be-recommended friend to the user. The personal information of the to-be-recommended friend includes the registered information, such as the user name for example. In an alternative embodiment, the recommending module 104 may determine which of the determined similarity value between the determined image character and the stored image character is greater than a preset similarity value, and recommend at least one to-be-recommended friend to the user according to the determined result.

In the embodiment, the system 100 further includes an updating module 105. The updating module 105 stores the determined image character of images uploaded by the user to the storage unit 10 when the recommending module 104 has determined to recommend which of the to-be-recommended friends to the user, thereby updating the stored image characters in the storage unit 10.

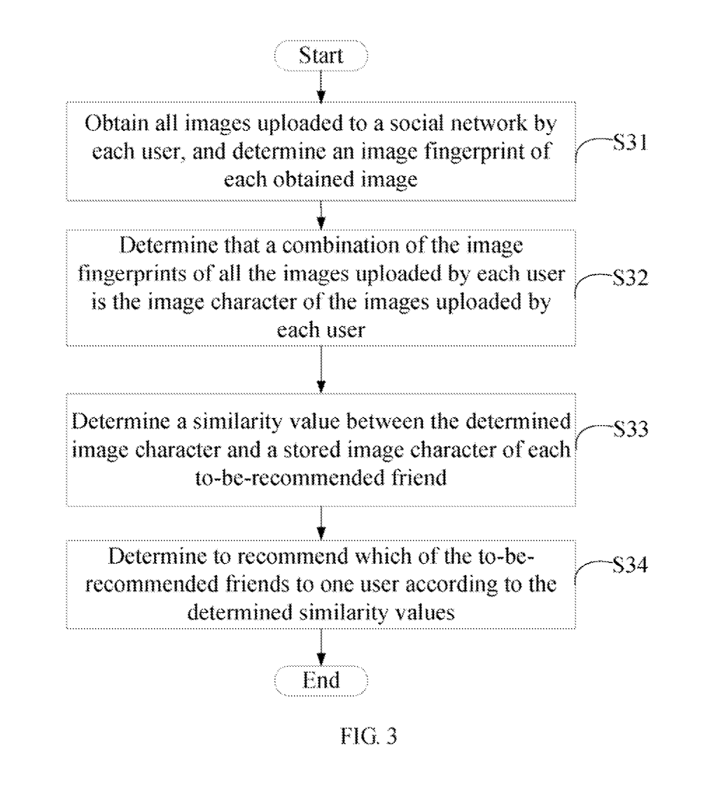

FIG. 3 is a flowchart of a friend recommendation method, in accordance with an exemplary embodiment.

In step S31, the analyzing module 101 obtains all the images uploaded to the social network 1 by each user, and determines an image fingerprint of each obtained image.

In step S32, the combining module 102 determines that a combination of the image fingerprints of all the images uploaded by each user is the image character of the images uploaded by the user.

In step S33, the matching module 103 compares the determined image character with the stored image character of each to-be-recommended friend, and determines a similarity value between the determined image character and each stored image character according to the comparison result.

In step S34, the recommending module 104 determines to recommend which of the to-be-recommended friends to one user according to the determined similarity values.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A social network comprising:
a storage unit storing a relationship between to-be-recommended friends and image characters of images uploaded by each to-be-recommended friend; and
a processor to execute a plurality of modules,
wherein the plurality of modules comprise:
an analyzing module to obtain all images uploaded to the social network by a user, and determine an image fingerprint of each obtained image;
a combining module to determine that a combination of the image fingerprints of all the images uploaded by the user is an image character of the images uploaded by the user;
a matching module to compare the determined image character with the stored image character of each to-be-recommended friend, and determine a similarity value between the determined image character and each stored image character according to a comparison result; and
a recommending module to determine to recommend which of the to-be-recommended friends to one user according to the determined similarity values.

2. The social network of claim 1, wherein the analyzing module is configured to automatically obtain all the images uploaded to the social network by one user each time the user uploads an image.

3. The social network of claim 1, wherein the analyzing module is configured to obtain all the images uploaded to the social network by one user upon receiving a command input by the user.

4. The social network of claim 1, wherein the analyzing module is configured to determine the image fingerprint of each obtained image by a Message Digest Algorithm 5 checksum.

5. The social network of claim 1, wherein the analyzing module is configured to first identify human faces comprised in each obtained image, determine a binary sequence corresponding to each identified human face, and determine that a combination of the binary sequence corresponding to each identified human face in each obtained image is the image fingerprint of each obtained image.

6. The social network of claim 1, wherein the matching module is configured to compare the binary sequences in the determined image character with the binary sequences in each stored image character, calculate a number of same binary sequences between the determined image character and each stored image character, and determine the similarity value between the determined image character and each stored image character according to the calculated number.

7. The social network of claim 1, wherein the recommending module is configured to determine the stored image character with a highest similarity value relative to the determined image character, and recommend at least one to-be-recommended friend corresponding to the determined stored image character to the user by sending personal information of the to-be-recommended friend to the user.

8. The social network of claim 1, wherein the recommending module is configured to determine which of the determined similarity value between the determined image character and the stored image character is greater than a preset similarity value, and recommend at least one to-be-recommended friend to the user according to a determined result.

9. The social network of claim 1, wherein the plurality of modules further comprises an updating module, the updating module is configured to store the determined image character of the user to the storage unit when the recommending module has determined to recommend which of the to-be-recommended friends to the user.

10. A friend recommendation method applied for a social network, the social network comprising a storage unit for storing a relationship between to-be-recommended friends and image characters of images uploaded by each to-be-recommended friend, the method comprising:
obtaining all images uploaded to the social network by each user;
determining an image fingerprint of each obtained image;
determining that a combination of the image fingerprints of all the images uploaded by the user is an image character of the images uploaded by the user;
comparing the determined image character with the stored image character of each to-be-recommended friend;
determining a similarity value between the determined image character and each stored image character according to a comparison result; and
determining to recommend which of the to-be-recommended friends to one user according to the determined similarity values.

11. The friend recommendation method of claim 10, wherein the images uploaded to the social network by each user are automatically obtained each time the user uploads an image.

12. The friend recommendation method of claim 10, wherein the images uploaded to the social network by each user are obtained upon receiving a command input by the user.

13. The friend recommendation method of claim 10, wherein the image fingerprint of each obtained image is determined by a Message Digest Algorithm 5 checksum.

14. The friend recommendation method of claim 10, wherein the step determining an image fingerprint of each obtained image further comprises:
identifying human faces comprised in the obtained image;
determining a binary sequence corresponding to each identified human face; and
determining that a combination of the binary sequence corresponding to each identified human face in the obtained image is the image fingerprint of the obtained image.

15. The friend recommendation method of claim 10, wherein the step determining a similarity value between the determined image character and each stored image character according to a comparison result further comprises:
comparing the binary sequences in the determined image character with the binary sequences in each stored image character;
calculating a number of same binary sequences between the determined image character and each stored image character; and
determining the similarity value between the determined image character and each stored image character according to the calculated number.
